(19) United States
(12) Patent Application Publication
(10) Pub. No.: US 2022/0076195 A1
(43) Pub. Date: Mar. 10, 2022

(54) EXTRACTION-BASED CONTRACT EXECUTION

(71) Applicant: Radient Technologies Innovations Inc., Edmonton (CA)

(72) Inventors: Michael Cabigon, Edmonton (CA); Jim Seethram, Edmonton (CA); Steven Splinter, Edmonton (CA); Denis Taschuk, Edmonton (CA)

(21) Appl. No.: 17/240,452

(22) Filed: Apr. 26, 2021

Related U.S. Application Data
(63) Continuation of application No. PCT/IB2019/058922, filed on Oct. 18, 2019.
(60) Provisional application No. 62/750,202, filed on Oct. 24, 2018.

(51) Int. Cl. G06Q 10/08; G06Q 50/18

(52) U.S. Cl. CPC G06Q 10/087; G06Q 50/18

(57) ABSTRACT

The present disclosure is directed to methods and apparatus for processing cannabis plant matter according to a set of contractual requirements. These contractual requirements may identify a type of cannabis plant matter, a mass of cannabis plant matter available for extraction, a concentration of cannabinoids that should be included in the mass of cannabis plant matter, or other factors. Sensor data may be received that includes data that can be used to validate that the cannabis plant matter available for extraction is consistent with the identified type of cannabis plant matter. After a set of contractual requirements have been validated, the mass of cannabis plant matter may be processed by an extractor that extracts cannabinoids from the cannabis plant matter and then a bill may be sent to a computer of a customer such that payment for the extraction processing may be received.

### CROSS-REFERENCE TO RELATED APPLICATIONS

The present patent application is a continuation of International Application No. PCT/IB2019/058922 filed Oct. 18, 2019, which claims priority benefit of U.S. provisional patent application number 62/750,202 filed on Oct. 24, 2018, the disclosures of which are incorporated by reference herein.

### BACKGROUND OF THE INVENTION

### 1. Field of the Invention

The present disclosure is generally related to comparing data sensed from a batch of cannabis plant matter with contractual requirements for processing a type of cannabis plant matter before processing the batch of cannabis plant matter. More specifically the present disclosure is directed to monitoring the processing of cannabis plant matter and to billing for the use of cannabis extraction equipment.

### 2. Description of the Related Art

Cannabis is a genus belonging to the family of cannabaceae. Three common species include Cannabis sativa, Cannabis indica, and Cannabis ruderalis. Cannabis has a long history being used for medicinal, therapeutic, and recreational purposes. Historical delivery methods for cannabis have involved smoking (e.g., combusting) the dried cannabis plant material. Alternative delivery methods such as ingesting typically require extracts of the cannabis biomass (also known as cannabis concentrates or cannabis oils). Often, cannabis extracts are formulated using any convenient pharmacologically or food-grade acceptable diluents, carriers or excipients to produce a composition, which collectively may be known as cannabis derivative products or cannabis products. These may for example include cannabis topicals, edibles, or vaping products.

Cannabis extracts may be obtained from cannabis by any number of methods, including but not limited to supercritical fluid extraction, solvent extraction of microwave-assisted extraction. In some cases, manufacturers of the equipment for extraction may wish to sell equipment to third parties for use in manufacturing cannabis concentrates or cannabis products. Similarly, owners of certain proprietary extraction systems and methods may wish to sell specific extraction equipment or license the equipment and process details to third parties for use in manufacturing cannabis concentrates or cannabis products.

There is a need for cannabis equipment vendors and methods and systems owners to have a smart billing system for the use of cannabis extraction equipment that bills based on actual equipment usage. Further, there is a need for such vendors and owners to maintain a level of tracking necessary for regulatory compliance. This is a new business model for Cannabis extraction for charging for fractional use of extraction equipment.

### SUMMARY OF THE CLAIMED INVENTION

The presently claimed invention relates to a method, a non-transitory computer readable storage medium, or an apparatus executing functions consistent with the present disclosure. A method consistent with the present disclosure may receive a set of reference data associated with identifying and processing a type of cannabis plant matter after which sensor data may be received from a sensor that senses a sample of a new batch of cannabis plant matter. Next, the comparison may be used to identify that the sample of the new batch of cannabis plant matter is consistent with the type of cannabis plant matter. The new batch of cannabis plant matter may be allowed to be processed based on the new batch of cannabis plant matter being consistent with the type of cannabis plant matter.

When the presently claimed invention is implemented as a non-transitory computer-readable storage medium, a processor executing instructions out of a memory may perform a method consistent with the present disclosure. Here again the method may include receiving a set of reference data associated with identifying and processing a type of cannabis plant matter after which sensor data may be received from a sensor that senses a sample of a new batch of cannabis plant matter. Next, the comparison may be used to identify that the sample of the new batch of cannabis plant matter is consistent with the type of cannabis plant matter. The new batch of cannabis plant matter may be allowed to be processed based on the new batch of cannabis plant matter being consistent with the type of cannabis plant matter.

An apparatus consistent with the present disclosure may include a sensor that senses a sample of a new batch of plant matter, a memory, and a processor that executes instructions out of the memory. The processor may execute instructions to receive a set of reference data associated with identifying and processing a type of cannabis plant matter and to receive data from the sensor that senses the sample from a new batch of cannabis plant matter. The processor may also identify that the sample of new batch of cannabis plant matter is consistent with the type of cannabis plant matter based on a comparison of the sensor data with the set of reference data, and allow the new batch cannabis plant matter to be processed based on the identification that the cannabis plant matter is consistent with the type of cannabis plant matter.

### BRIEF DESCRIPTIONS OF THE DRAWINGS

FIG. 1 illustrates an exemplary network environment in which a system for smart contracts for cannabis extraction services may be implemented.

FIG. 2 is a flowchart illustrating an exemplary method for smart contract execution and control management.

FIG. 3 is a flowchart illustrating an exemplary method for identifying when received optical data is consistent with current or new contract conditions.

FIG. 4 is a flowchart illustrating an exemplary method for secure contract management.

FIG. 5 illustrates a computing system that may be used to implement an embodiment of the present invention.

### DETAILED DESCRIPTION

The present disclosure is directed to methods and apparatus for processing cannabis plant matter according to a set of contractual requirements. These contractual requirements may identify a type of cannabis plant matter, a mass of cannabis plant matter available for extraction, a concentration of cannabinoids that should be included in the mass of cannabis plant matter, or other factors. Sensor data may be received that includes data that can be used to validate that the cannabis plant matter available for extraction is consistent with the identified type of cannabis plant matter. After a set of contractual requirements have been validated, the mass of cannabis plant matter may be processed by an extractor that extracts cannabinoids from the cannabis plant matter and then a bill may be sent to a computer of a customer such that payment for the extraction processing may be received.

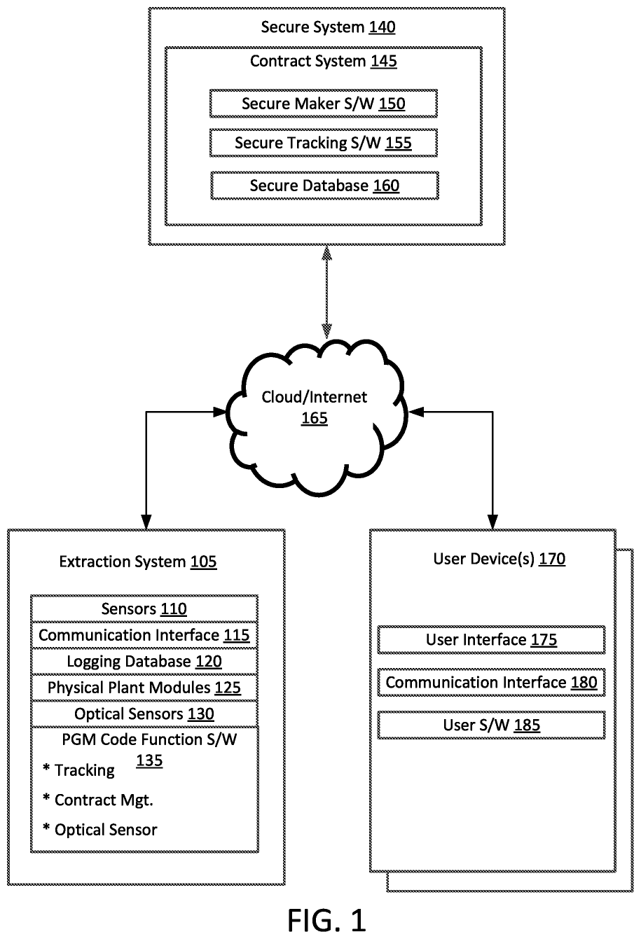

FIG. 1 illustrates an exemplary network environment in which a system for smart contracts for cannabis extraction services may be implemented. In certain instances, the devices illustrated in FIG. 1 may be part of a seed to sale tracking and compensation system that may include a blockchain-based distributed or supply-chain ledger. FIG. 1 includes an extraction system 105, a secure system 140, and a user device 170 that may communicate over the cloud or Internet 165. Extraction system 105 includes sensors 110, communication interface 115, logging database 120, physical plant modules 125, optical sensors 130, and program code software 135. Program code functions performed by extraction include the management of data relating to the fulfillment of contracts (contract management), the tracking of the status of contracted services, and the evaluation of optical or other sensor data. Functions performed by extraction system 105 include extracting cannabinoids from cannabis plant matter/biomass. The physical plant modules 125 may include hardware components of a cannabis plant matter extraction system 105, these hardware components may include an electronic control system coupled to sensors 110 and may include individual pieces of extraction equipment. This control system may be used to adjust the operation of the individual pieces of extraction equipment such that extractions performed on cannabis plant matter may be adjusted. Each of extraction system 105, secure system 140, and user devices 170 may include a memory and processor that executes instructions out of those memories when functions consistent with the present disclosure are performed.

Extraction system 105 may include a processor that executes program code stored in a memory when functions performed by extraction system 105 are controlled. Program code associated with managing the fulfillment of contracted services includes tracking software that tracks the production of cannabis concentrates and products. Tracking system program code at extraction system 105 may be used to ensure compliance with smart contract terms. The processor at extraction system 105 may track the fulfillment of contracted services by monitoring and evaluating sensor data. Various sensors 110 may be used to monitor the various physical plant modules related to cannabis to ensure compliance with “smart” contract terms. “Smart” contracts include agreements to perform extraction services according to a set of agreed upon contractual stipulations or requirements using computers that may monitor data from an extraction site. A processor executing a set of smart contract software may sense operating conditions and may inform operators when an extraction system can be allowed to perform an extraction according to conditions of a smart contract.

Optical sensors may be used to identify that received plant matter is consistent with contractual requirements, for example by identifying that the received plant matter is consistent with a cannabis strain that has been prepared for extraction. Optical software program code instructions executed by a processor at extraction system 105 may cause the processor to evaluate data collected optical sensors 125 at extraction system 105. The processor at extraction system 105 may store (log) optical sensor data and other data in logging database 120 of FIG. 1 when extractions are performed on cannabis plant matter. The optical sensor data collected and evaluated by a processor may cause that processor to provide the optical sensor data or results generated by the evaluation of received sensor data to tracking system program code at extraction system 105. The optical software could perform simple functions of receiving image data and assigning a tracking identifier to a new batch of cannabis plant biomass. In such an instance, an imager may acquire picture image data of the cannabis plant biomass that has been prepped for processing. These images may have been acquired when the cannabis plant biomass is packed inside of a tote or container. The optical software could, for instance, allow a processor to evaluate image data of the new batch of cannabis plant biomass when matching this batch of biomass to images of known types of cannabis plant biomass. As such, the processor may execute image recognition program code when comparing a library of images that are representative of different specific types of cannabis plant biomass when validating that the new batch of cannabis plant biomass is consistent with a specific type of cannabis plant biomass.

The logging database 120 of extraction system 105 used to store/log contractual requirements, transaction details, and data collected when extraction system 105 operates. The cloud or Internet communication network may be a wired and/or a wireless network. Communication interface 115 may allow a computer at extraction system 105 communicate with other computing devices over the cloud or internet 165. Communication interface 115 may be consistent with any type of communication network known in the art, wired or wireless. In instances when communication interface 115 is a wireless interface, communications may be sent or received using any communication technique, including, yet not limited to visible light communication (VLC), worldwide interoperability for microwave access (WiMAX), long term evolution (LTE), wireless local area network (WLAN), infrared (IR) communication, public switched telephone network (PSTN), radio waves, or other communication techniques known in the art. The communication network may allow ubiquitous access to shared pools of configurable system resources and higher-level services that can be rapidly provisioned with minimal management effort.

Data may frequently be transmitted via the Internet between extraction system 105, secure system 140, or user device 170. Methods and apparatus consistent with the present disclosure may rely on the sharing of resources to achieve coherence and economies of scale, like a public utility, while third-party clouds enable organizations to focus on their core businesses instead of expending resources on computer infrastructure and maintenance. Secure system 140 may control the receipt and fulfillment of contracted services and may serve as a secure repository for storing “smart” contract information. Secure system 140 may be operated by a third party or by the owner of extraction system 105. The secure contract system 145 may be a system which allows users (e.g. clients or customers) and extractors to create and abide by the terms of a smart contract. The secure maker software 140 of secure system 140 is program code that may be used for the creation and retention of smart contract data. Although not shown in FIG. 1, the secure maker software 140 program code may be capable of storing and annotating contracts by users (clients/customers) or operators of extraction equipment. In instances when annotations are received by a computing device, they may be shared with other computing devices automatically or these annotations may be sent to other computing devices when prompted.

The secure tracking software 155 at contract system 145 is program code that may help guarantee that the implementation of a smart contract is performed according to conditions or rules of a contractual agreement. While not illustrated in FIG. 1, contract system 145 may include software that authorizes payment for services rendered. Secure system 140 may provide compensation in the form of crypto-currency or may cause funds to be wired to accounts when certain contractual stipulations have been fulfilled. Secure database 160 is a database for saving smart contracts and their associated terms or rules.

User devices 170 may be computing devices that are owned by individual users or companies that have contracted or intend to contract extraction services from an extractor. While user devices 170 of FIG. 1 are illustrated as including user interface 175, communication interface 180, and user software 185, these devices may also include a processor that executes instructions out of a memory. User devices 170 may be any computing device known in the art, such as a cell phone, a tablet computer, or other computing device. Users that own user devices 170 may be employees of entities that use specific cannabis extracts to make consumable cannabinoid containing products. When a user or company desires to contract with an extractor to extract cannabinoids from cannabis plant matter, these users or companies may be provided with information that identifies the capabilities of extraction system 105 such that they may be able to order extraction services that will produce specific types of cannabis extracts or masses (amounts) of cannabinoids in a distillate or isolate form that meets their needs. User interface 175 is an interface that users may interact with when sending or receiving communications from secure system 140 via the cloud or Internet 165. User software 185 is a set of program code that may allow users to create and commit to terms of a smart contract.

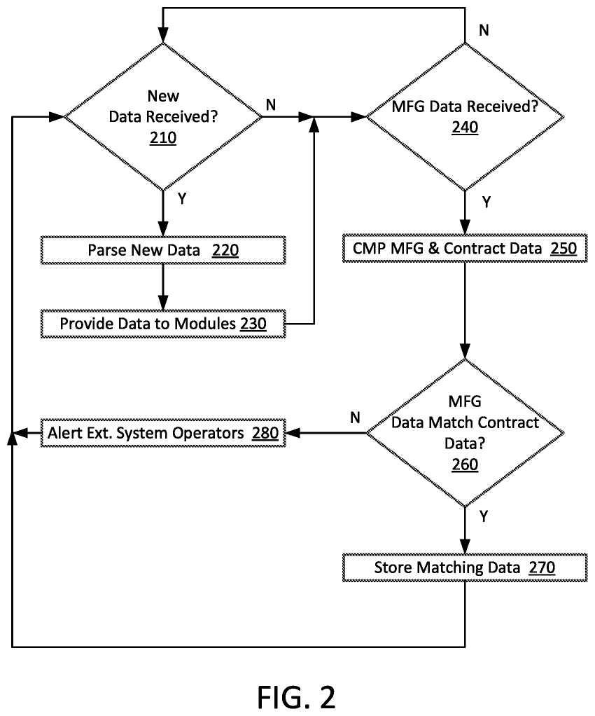

FIG. 2 is a flowchart illustrating an exemplary method for smart contract execution and control management. A processor executing instructions at extraction system 105 may receive data from the contract system 145 at secure computer system 140 of FIG. 1 when performing the steps illustrated in FIG. 2. FIG. 2 begins with determination step 210 that identifies whether new data has been received from tracking software at an extraction system, when no, program flow may proceed to step 240. When determination step 210 identifies that new tracking data has been received, program flow moves to step 220, where the new data is parsed and reviewed. This review may cause portions of the relevant data to be sent to control the operation of the physical plant modules 125 of FIG. 1. Next, in step 230, the new data may be sent to the relevant physical plant models such that these modules are configured to control or monitor the operation of extraction equipment according to terms of a contract. Next, the parsed data is sent to relevant physical plant modules. This data may setup or change operating characteristics at a piece of extraction equipment or may configure settings, enable sensors, or set warning levels that may cause functions to be performed at the piece of extraction equipment. After step 230 program flow moves to determination step 240 that may identify whether new manufacturing data has been received, when no, program flow moves back to determination step 210. When new manufacturing data has been received, program flow may move to step 250 where the manufacturing data is compared to requirements of a service contract (smart contract data). This may include comparing the data associated with the parsing step 220 with manufacturing data. Next in determination step 260, the manufacturing data may be compared to the smart contract data when determining whether the manufacturing data matches the smart contract data according to contract terms, when yes, program flow moves to step 270 where the matching data is store at a database. When determination step 260 identifies that the manufacturing data does not match the contract terms or data, program flow moves to step 280 where alerts may be sent to operators of the extraction system. Step 280 may also cause extraction operations to be paused or may cause operational parameters to be updated in an attempt to cause the extraction system to change operating conditions. Data regarding the manufacturing data not matching the contract data or requirements may be stored in the logging database 120 of FIG. 1. After either step 270 or step 280 of FIG. 2, program flow flows back to determination step 210.

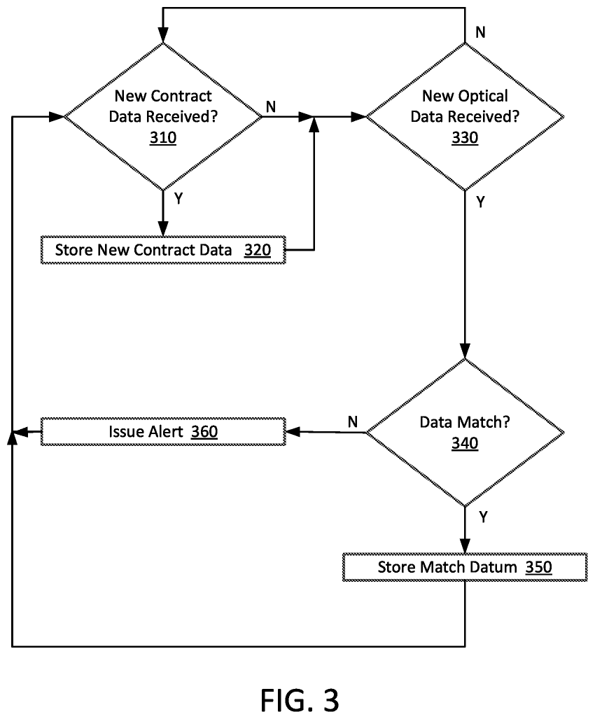

FIG. 3 is a flowchart illustrating an exemplary method for identifying when received optical data is consistent with current or new contract conditions. Determination step 310 may identify whether new contractual requirements or data have been received, when no, program flow may move to determination step 330. When determination step 310 identifies that new contract data or requirements have been received in step 310, program flow may move to step 320 where that new data or requirements are stored in a database. Program flow may then move to step 330 that determines whether new optical data has been received, when no, program flow may move back to step 310 of FIG. 3. New contractual requirements and data may be received by a computer at extraction system 105 that were sent from secure system 140 as part of operations consistent with the function of contract system software 145 of FIG. 1.

When new optical data is identified as having been received in step 330, program flow may move to determination step 340 that identifies whether the new optical data matches contract requirements and contract data. This new optical data may be associated with a batch of cannabis plant matter of a type stipulated by contract requirements that has certain characteristics (e.g. colors). For example, contract requirements may stipulate that a current lot of plant matter should be cannabis sativa and image data used to identify cannabis sativa flowers may be provided to extraction system 105 as contract data. The newly received optical data may be compared to the contract requirements and contract data in step 330. This may include comparing characteristics of cannabis plant material in the newly acquired image data with contractual image data. In the instance where the contract stipulates that a current extraction should be performed of cannabis sativa plant matter, colors or color spectra included in the contractual image data may be compared to see if it is consistent with colors or color spectra in the newly received optical data. When these colors or spectra match, determination step may move to step 350 where an indication (datum) indicating that the new batch of plant matter is consistent with contractual requirements is stored in the logging database. This may indicate that the smart contract has been fulfilled.

In instances when determination step 340 identifies that the new optical data does not match the contractual requirements or data, program flow may move to step 360 where an alert is issued. Such an alert may be sent to computing devices of extraction equipment operators or other users. As such, user devices 170 may receive these alerts. These alerts may also cause extraction equipment to be temporarily shut down.

Organization of a logging database consistent with the present disclosure will now be explained with reference to table 1. The logging database of table 1 includes data that cross-references contract data and findings with different cannabis lots identified by a record number. Table 1 includes rows of (a) record identifier (ID), (b)Contract ID, (c) Strain, (d) Optical Data, (e) whether or not there is a Strain Match?, (f) the Amount of the Cannabis for the contract, (g) Amount Matched, (h) Concentration, (i) Concentration Matched, (j) Time : Date Completed. The data included in table 1 includes different cannabis types (Motor Breath, Silver Bullet, & proprietary blend #15) that may have been identified using optical data. Note that each record ID has been assigned a different contract identifier and a different set of optical data. Optical data, weight data, and concentration percentages may be part of a set of requirements used to identify whether a current batch of plant matter matches contractual requirements. For example image data of samples of Motor Breath cannabis may be compared to newly acquired images, weights, or other test data when determining that the current batch of plant matter is the correct strain, at a correct concentration, or a correct weight. Note that table 1 identifies that for each record ID 51, 52, and 54 that there is a strain match (Y), with a correct weight (amount), and that the plant matter has the correct cannabinoid concentration per unit mass of plant matter. Note also that each record ID is associated with a time and date of processing.

TABLE 1
Contract Data vs. Cannabis Lot Information

| Record ID | 51 | 52 | 54 |
|---|---|---|---|
| Strain | Motor Breath | Silver Bullet | Proprietary |
| | | | Blend #15 |
| Contract ID | 5446548 | 2657465 | 842156 |
| Optical Data | ID 501 | Biomass 571 | ID 701 |
| Strain Match | Y | Y | Y |
| Amount/Mass | 50 g | 245 g | 5000 g |
| Amount | Y | Y | In Process |
| Match | | | |
| Concentration | 80% | 65% | 99.9% |
| Concentration | Y | Y | |
| Match | | | |
| Time:Date | 1500:08-29-2019 | 1645:08-29-2019 | 0800:08-31-2019 |

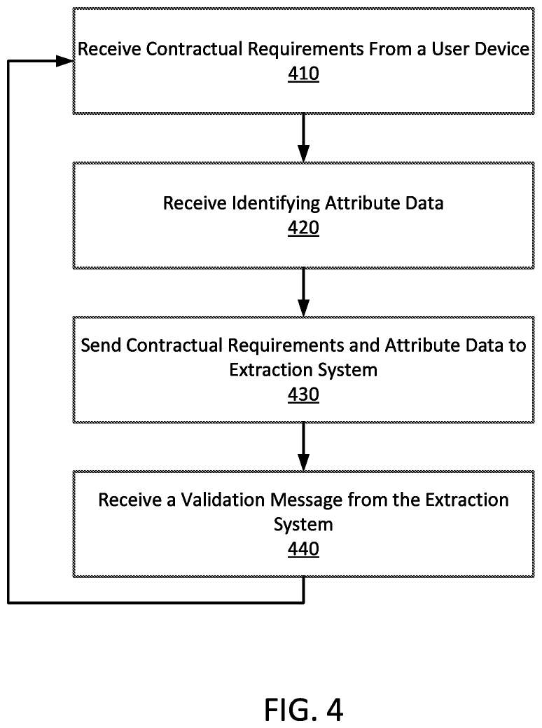

FIG. 4 is a flowchart illustrating an exemplary method for secure contract management. The steps of FIG. 4 may be performed by secure computer system 140 of FIG. 1 when that system receives requirements from a user device 170 and sends information to extraction system 105. Contractual requirements may be received from a user device in step 410, these requirements may stipulate that a next extraction should be performed on 10 kg of low THC hemp. Next identifying attribute data could include reference images of flowers of low THC hemp plants that can be received in step 420 and then in step 430, the contractual requirements and the identifying attribute data may be sent to the extraction system. The extraction system may then perform extractions after a set of comparisons have been performed. These comparisons may compare reference images with newly received images of a current lot of plant matter and may compare expected weights of that plant matter with actual weights of that plant matter as measured by a scale. When comparisons match contractual stipulations, a validation message may be received from the extraction system.

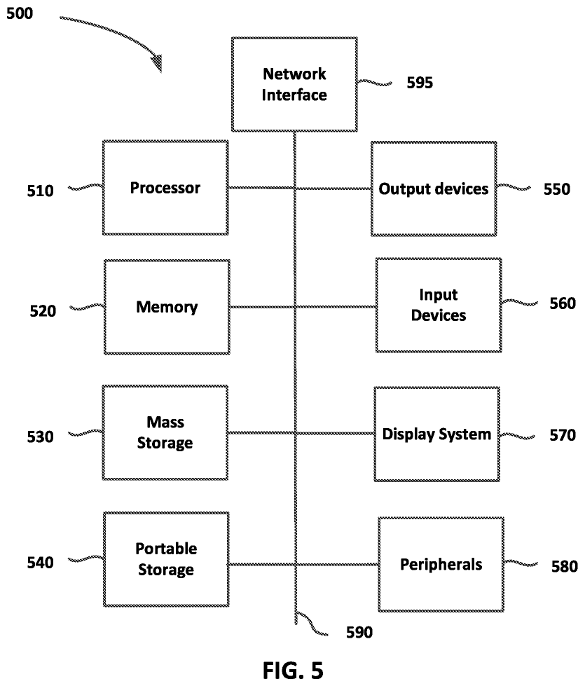

FIG. 5 illustrates a computing system that may be used to implement an embodiment of the present invention. The computing system 500 of FIG. 5 includes one or more processors 510 and main memory 520. Main memory 520 stores, in part, instructions and data for execution by processor 510. Main memory 520 can store the executable code when in operation. The system 500 of FIG. 5 further includes a mass storage device 530, portable storage medium drive(s) 540, output devices 550, user input devices 560, a graphics display 570, peripheral devices 580, and network interface 595.

The components shown in FIG. 5 are depicted as being connected via a single bus 590. However, the components may be connected through one or more data transport means. For example, processor unit 510 and main memory 520 may be connected via a local microprocessor bus, and the mass storage device 530, peripheral device(s) 580, portable storage device 540, and display system 570 may be connected via one or more input/output (I/O) buses.

Mass storage device 530, which may be implemented with a magnetic disk drive or an optical disk drive, is a non-volatile storage device for storing data and instructions for use by processor unit 510. Mass storage device 530 can store the system software for implementing embodiments of the present invention for purposes of loading that software into main memory 520.

Portable storage device 540 operates in conjunction with a portable non-volatile storage medium, such as a FLASH memory, compact disk or Digital video disc, to input and output data and code to and from the computer system 500 of FIG. 5. The system software for implementing embodiments of the present invention may be stored on such a portable medium and input to the computer system 500 via the portable storage device 540.

Input devices 560 provide a portion of a user interface. Input devices 560 may include an alpha-numeric keypad, such as a keyboard, for inputting alpha-numeric and other information, or a pointing device, such as a mouse, a trackball, stylus, or cursor direction keys. Additionally, the system 500 as shown in FIG. 5 includes output devices 550. Examples of suitable output devices include speakers, printers, network interfaces, and monitors.

Display system 570 may include a liquid crystal display (LCD), a plasma display, an organic light-emitting diode (OLED) display, an electronic ink display, a projector-based display, a holographic display, or another suitable display device. Display system 570 receives textual and graphical information, and processes the information for output to the display device. The display system 570 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 580 may include any type of computer support device to add additional functionality to the computer system. For example, peripheral device(s) 580 may include a modem or a router.

Network interface 595 may include any form of computer interface of a computer, whether that be a wired network or a wireless interface. As such, network interface 595 may be an Ethernet network interface, a BlueTooth™ wireless interface, an 802.11 interface, or a cellular phone interface.

The components contained in the computer system 500 of FIG. 5 are those typically found in computer systems that may be suitable for use with embodiments of the present invention and are intended to represent a broad category of such computer components that are well known in the art. Thus, the computer system 500 of FIG. 5 can be a personal computer, a hand held computing device, a telephone (“smart” or otherwise), a mobile computing device, a workstation, a server (on a server rack or otherwise), a minicomputer, a mainframe computer, a tablet computing device, a wearable device (such as a watch, a ring, a pair of glasses, or another type of jewelry/clothing/accessory), a video game console (portable or otherwise), an e-book reader, a media player device (portable or otherwise), a vehicle-based computer, some combination thereof, or any other computing device. The computer can also include different bus configurations, networked platforms, multi-processor platforms, etc. The computer system 500 may in some cases be a virtual computer system executed by another computer system. Various operating systems can be used including Unix, Linux, Windows, Macintosh OS, Palm OS, Android, iOS, and other suitable operating systems.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASH EPROM, and any other memory chip or cartridge.

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

What is claimed is:

1. A method for contract-based control of cannabis processing, the method comprising:
storing a contract in memory in association with a set of reference parameters, the set of reference parameters associated with a type of cannabis plant matter;
receiving sensor data from a sensor, the sensor data concerning a current batch of cannabis plants of the same type;
identifying that the sensor data concerning the new batch of cannabis plants satisfies one or more of the reference parameters; and
processing the current batch of cannabis plants based on the identification.

2. The method of claim 1, wherein the set of reference parameters includes a measurement of mass, wherein the reference parameters are identified as satisfied based on the sensor data indicating that the current batch of cannabis plants meets the measurement of mass.

3. The method of claim 1, further comprising receiving the reference parameters from an external computer.

4. The method of claim 3, wherein the external computer is a user device that receives user input specifying the reference parameters.

5. The method of claim 1, wherein the sensor includes an optical sensor, and wherein the sensor data includes one or more images of the current batch captured by the optical sensor.

6. The method of claim 5, wherein the set of reference parameters includes an attribute of the cannabis plants, wherein the reference parameters are identified as satisfied based on the images being indicative of the attribute.

7. The method of claim 1, wherein the set of reference parameters includes a concentration of at least one cannabinoid, wherein the reference parameters are identified as satisfied based on the sensor data indicating that the current batch of cannabis plants meets the concentration of the at least one cannabinoid.

8. The method of claim 1, further comprising identifying which of the set of reference parameters are satisfied, wherein processing the current batch is based on the reference parameters identified as satisfied.

9. The method of claim 1, further comprising identifying a cost of processing the new batch based on the satisfied reference parameters, and transmitting the identified cost to a recipient device.

10. A system for contract-based control of cannabis processing, the system comprising:
memory that stores a contract in association with a set of reference parameters, the set of reference parameters associated with a type of cannabis plant matter;
a sensor that captures sensor data concerning a current batch of cannabis plants of the same type;
a processor that executes instructions stored in memory, wherein the processor executes the instructions to identify that the sensor data concerning the new batch of cannabis plants satisfies one or more of the reference parameters; and
an extraction system that processes the current batch of cannabis plants based on the identification.

11. The system of claim 10, wherein the set of reference parameters includes a measurement of mass, wherein the reference parameters are identified as satisfied based on the sensor data indicating that the current batch of cannabis plants meets the measurement of mass.

12. The system of claim 10, further comprising a communication network interface that receives the reference parameters from an external computer.

13. The system of claim 12, wherein the external computer is a user device that receives user input specifying the reference parameters.

14. The system of claim 10, wherein the sensor includes an optical sensor, and wherein the sensor data includes one or more images of the current batch captured by the optical sensor.

15. The system of claim 14, wherein the set of reference parameters includes an attribute of the cannabis plants, wherein the reference parameters are identified as satisfied based on the images being indicative of the attribute.

16. The system of claim 10, wherein the set of reference parameters includes a concentration of at least one cannabinoid, wherein the reference parameters are identified as satisfied based on the sensor data indicating that the current batch of cannabis plants meets the concentration of the at least one cannabinoid.

17. The system of claim 10, wherein the processor further identifies which of the set of reference parameters are satisfied, wherein the current batch is processed based on the reference parameters identified as satisfied.

18. The system of claim 10, wherein the processor further identifies a cost of processing the new batch based on the satisfied reference parameters, and transmits the identified cost to a recipient device.

19. A non-transitory, computer-readable storage medium, having embodied thereon a program executable by a processor to perform a method for contract-based control of cannabis processing, the method comprising:
storing a contract in memory in association with a set of reference parameters, the set of reference parameters associated with a type of cannabis plant matter;
receiving sensor data from a sensor, the sensor data concerning a current batch of cannabis plants of the same type;
identifying that the sensor data concerning the new batch of cannabis plants satisfies one or more of the reference parameters; and
processing the current batch of cannabis plants based on the identification.
